(19) United States
(12) Patent Application Publication
(10) Pub. No.: US 2020/0351374 A1
(43) Pub. Date: Nov. 5, 2020

(54) SYSTEM AND METHOD FOR MANAGING AND SHARING DATA ACROSS UNAFFILIATED COMPUTING SYSTEMS

(71) Applicant: Genesys Telecommunications Laboratories, Inc., Daly City, CA (US)

(72) Inventors: Christian Eberle, Charlottesville, VA (US); Alexandria Hockeborn, Boynton Beach, FL (US)

(21) Appl. No.: 16/403,348

(22) Filed: May 3, 2019

(51) Int. Cl. H04L 29/08; G06Q 50/14; G06F 21/62; G06F 21/31

(52) U.S. Cl. CPC H04L 67/306; H04L 67/327; G06F 21/31; G06F 21/6245; G06Q 50/14

(57) ABSTRACT

A system and method for managing and sharing data across a plurality of computing systems of different entities from a central data vault. A computerized set of rules and actions are identified and stored in association with a customer profile in the data vault. The data vault monitors for a trigger event from a first entity selected by the customer as a trusted entity. The data vault determines whether the trigger event is identified in the set of rules and actions stored in association with the customer. In response to identifying the trigger event in the set of rules and actions, the data vault identifies a command from the set of rules and actions corresponding to the trigger event, and transmits the command to a second entity that has also been selected by the customer as being a trusted entity. The command may be for triggering action by the second entity.

### CROSS-REFERENCE TO RELATED APPLICATION

This application is related to U.S. application Ser. No. 15,717,509, filed on Sep. 27, 2017, the content of which is incorporated herein by reference.

### FIELD

Aspects of the invention relate to the field of communication management, and more particularly to managing and automatically sharing information between computing systems that would typically not have such automatic access.

### BACKGROUND

When planning a vacation, an individual may make arrangements with a number of businesses or services within the travel industry. The interactions with the various businesses to achieve a particular goal may be referred to as a journey. For example, an individual may book an airline ticket, make hotel and car rental reservations, and the like. Oftentimes, such related businesses, which operate within the same broad industry, do not share customer activity information due to, for example, privacy and security concerns, business competition, and the like. This often results a loss of quality of service and context along the journey pathway. Thus, when an individual's travel plans change, s/he generally has to separately contact each business or service (e.g., the airline, hotel, car rental company) to make the appropriate change to the reservation or arrangement. This may be a cumbersome and time consuming process for the individual to undertake, and a failure to contact even one of the businesses or services may result in great inconvenience and cost to the individual, and may even lead to a loss of profits for the uninformed business. For instance, if a planned vacation is postponed, but the individual forgets to inform the hotel of the later arrival date, the individual may arrive at the destination only to find that no rooms are available at the hotel or that the cost of staying at the hotel has sharply increased.

In addition, using traditional mechanisms in interacting with the various businesses, customers are not able to control and update journey-specific data points that would be pertinent to multiple journeys and multiple business interactions. This might result in customers losing convenience and simplicity across an established journey, and businesses losing opportunities to gather and act on additional pieces of context across a customer-specific journey existing across multiple businesses.

Thus, what is desired is system and method that allows the sharing of customer data across multiple businesses from a central location, and under control of the customer that owns the data.

The above information disclosed in this Background section is only for enhancement of understanding of the background of the invention, and therefore it may contain information that does not form the prior art that is already known to a person of ordinary skill in the art.

### SUMMARY

According to one embodiment, a method is provided for managing and sharing data across a plurality of computing systems. The method includes identifying, by a processor, a computerized set of rules and actions. The processor stores the identified set of rules and actions in association with a specific user of a plurality of users, and monitors for a trigger event from a first computing system of the plurality of computing systems. The trigger event may include, for example, first event data. The processor determines whether the trigger event is identified in the set of rules and actions stored in association with the specific user. In response to identifying the trigger event in the set of rules and actions, the processor identifies a command from the set of rules and actions corresponding to the trigger event, and transmits the command to a second computing system of the plurality of computing systems. In one embodiment, the command includes at least a portion of the first event data, where the command is for triggering action by the second computing system.

In one embodiment, the identifying, by the processor, of the computerized set of rules and actions includes receiving, by the processor, information on engagements by the specific user with a first entity associated with the first computing system, and a second entity associated with the second computing system; predicting, by the processor, the set of rules and actions correlated to the received information; and recommending, by the processor, the predicted set of rules and actions.

In one embodiment, the predicting, by the processor, of the set of rules and actions includes maintaining, by the processor, a statistical model modeling a correlation between a plurality of inputs and a plurality of sets of rules and actions; providing, by the processor, the information on engagements by the specific user, as input to the statistical model; and selecting, by the processor, the predicted set of rules and actions, where the predicted set of rules of actions are predicted to be correlated to the information on engagements by the specific user, within a threshold level of confidence.

In one embodiment, the trigger event is generated in response to a first engagement between the specific user and the first computing system, and the first event data includes data associated with the first engagement.

In one embodiment, the processor receives user selection of a first entity associated with the first computing system, and a second entity associated with the second computing system. The processor authenticates the specific user with each of the first and second entities, and links the first and second entities to a user profile of the specific user.

In one embodiment, the monitoring of the trigger event from the first computing system is in response to the linking of the first entity to the user profile of the specific user.

In one embodiment, the set of rules and actions is further linked to the first and second entities without linking to a third entity. The processor receives the trigger event from a third computing system of the plurality of computing systems associated with the third entity, and ignores the received trigger event from the third computing system.

In one embodiment, the action triggered via the command is an interaction between the specific user and the second computing system.

In one embodiment, the first computing system includes a server for providing contact center services to customers of the first entity, and the second computing system includes a server for providing contact center services to customers of the second entity.

According to one embodiment, a system is also provided for managing and sharing data across a plurality of computing systems. The system may include a mass data storage device, a processor coupled to the mass data storage device, and a memory coupled to the processor. In one embodiment, the memory provides instructions that, when executed by the processor, cause the processor to take certain actions. Those actions may include providing a portal accessible to a user, where the portal is for prompting the user to identify a plurality entities, where each of the plurality of entities is associated with a different computing system of the plurality of computing systems. The actions to be taken by the processor may further include receiving user authentication information for each of the plurality of entities, and exchanging messages with each of the plurality of entities based on the corresponding user authentication information for authenticating the user to each of the plurality of entities. The actions to be taken by the processor may also include identifying a set of computerized rules and actions involving first and second entities of the plurality of entities, and storing the identified set of rules and actions in the mass data storage device in association with the user. The computer instructions may also cause the processor to receive an event from the computing system associated with the first entity. The event may be generated in response to a first engagement between the user and the first entity, and may include event data associated with the first engagement. The instructions may further cause the processor to determine whether the event is identified in the set of rules and actions stored in association with the user. In response to identifying the event in the set of rules and actions, the instructions may further cause the processor to identify a command from the set of rules and actions corresponding to the event, and transmit the command to the computing system associated with the second entity. The transmitted command may include at least a portion of the event data, and may be for triggering action for a second engagement between the user and the second entity.

In one embodiment, the instructions that cause the processor to identify the computerized set of rules and actions further include instructions that cause the processor to: receive information on engagements by the specific user with the first and second entities; predict the set of rules and actions correlated to the received information; and recommend the predicted set of rules and actions.

In one embodiment, the instructions that cause the processor to predict include instructions that cause the processor to: maintain a statistical model modeling a correlation between a plurality of inputs and a plurality of sets of rules and actions; provide the information on engagements by the specific user, as input to the statistical model; and select the predicted set of rules and actions, wherein the predicted set of rules of actions are predicted to be correlated to the information on engagements by the specific user, within a threshold level of confidence.

In one embodiment, the instructions further cause the processor to, in response to authenticating the user to each of the plurality of entities, link the plurality of entities to a user profile of the user.

In one embodiment, the instructions that cause the processor to receive the event from the computing system associated with the first entity is in response to instructions that cause the processor to the link the first entity to the user profile of the specific user.

In one embodiment, the set of rules and actions is further linked to the first and second entities without linking to a third entity. According to this embodiment, the instructions further cause the processor to: receive the trigger event from a third computing system of the plurality of computing systems associated with the third entity; and ignore the received trigger event from the third computing system.

In one embodiment, the first computing system includes a server for providing contact center services to customers of the first entity, and the second computing system includes a server for providing contact center services to customers of the second entity.

In one embodiment, the instructions that cause the processor to receive the first event from the first computing system, and the instructions that cause the processor to transmit the command to the second computing system, further include instructions that cause the processor to receive and transmit over an application programming interface.

In one embodiment, the second engagement that is triggered between the user and the second entity is for modifying a result of a prior interaction between the user and the second entity.

In one embodiment, the first and second computing systems are each computing systems of a customer contact center.

As will be appreciated by a person of skill in the art, the system and method according to the various embodiments provide a technical improvement in the dissemination of information among contact center systems that is based on a set of rules and associated commands that may be referred to as journey recipes. The journey recipes may be automatically generated and recommended to users based on analysis of previous interactions or journeys by other people. One of the benefits of such journey recipes is that it allows intelligent dissemination of information to help make wise use of communication infrastructure as well as processing capabilities of the contact center systems receiving the disseminated information.

### BRIEF DESCRIPTION OF THE DRAWINGS

The accompanying drawings, together with the specification, illustrate example embodiments of the invention, and, together with the description, serve to explain the principles of the invention.

FIG. 1 is block diagram of a system that includes a data vault for managing and sharing customer data across computing systems of different brands according to one exemplary embodiment;

FIG. 2 is a more detailed block diagram of the data vault of FIG. 1, according to one exemplary embodiment;

FIG. 3 is a conceptual diagram of an AI engine for recommending journey recipes according to one exemplary embodiment;

FIG. 4 is a flow diagram of a process for managing and sharing customer data across multiple brands according to one exemplary embodiment;

FIG. 5 is a more detailed flow diagram of an act in FIG. 4, for controlling cross-entity sharing of the customer data with trusted brands according to one exemplary embodiment;

FIG. 6 is a schematic block diagram of a computing system of a contact center that supports a particular trusted brand according one exemplary embodiment;

FIGS. 7A-7D are block diagrams of a computing device, according to some exemplary embodiments of the present invention; and

FIG. 7E is a block diagram of a network environment including several computing devices, according to some exemplary embodiments of the present invention.

### DETAILED DESCRIPTION

In the following detailed description, only certain exemplary embodiments of the invention are shown and described, by way of illustration. As those skilled in the art would recognize, the invention may be embodied in many different forms and should not be construed as being limited to the embodiments set forth herein. Descriptions of features or aspects within each exemplary embodiment should typically be considered as available for other similar features or aspects in other exemplary embodiments. Like reference numerals designate like elements throughout the specification.

Today, consumers engage separately with different businesses, entities, companies, or brands, to acquire goods/services from each brand. The term “goods” and “services” are used interchangeably herein. The terms “businesses,” “entities,” “companies,” or “brands” are also used interchangeably herein.

When acquiring a particular service from a particular entity, valuable pieces of data are provided to the entity. For example, in applying for a car loan with a financial institution, the customer might provide, to the financial institution, the customer's income data, type of car to be purchased, and value of the car to be purchased. The same information, however, might also be required by a car insurance company in providing the customer with a car insurance quote. Without an infrastructure that allows the intelligent sharing of the data between the financial institution and the insurance company, the customer might have no other recourse than repeating the information that is provided to the financial institution, to the car insurance company.

In another example, a delay or cancellation of a person's flight may create the need to change a current hotel and car rental reservation dates and/or times. The change in such reservations generally cannot, and does not, happen until the customer initiates the conversation with each of these companies separately.

According to one embodiment, a system and method is provided that allows the intelligent sharing of data pertaining to a customer, including data of interactions between the customer and a trusted entity, to other trusted entities that are authorized by the customer. The data that is shared might include, for example, customer profile data, preference data, data provided during the interaction/engagement with the trusted entity, and/or any other data pertaining to the customer (hereinafter collectively referred to as customer data).

In one embodiment, the customer data is stored in a central data repository which may generally be referred to as a data vault. The customer controls and manages the customer data in the data vault via a brand portal. The customer may use the brand portal to select brands that may access and use the saved customer data to enhance the customer journey and the associated customer experience.

According to one embodiment, the sharing of data with the various brands is performed intelligently according to a set/grouping of rules and associated instructions, that determine when data is to be shared, what type of data is to be shared, and commands that are to be transmitted along with the shared data. The set or grouping of the rules and associated instructions may be referred to as “recipes.” In one embodiment, recipes are stored in association with specific customers, and invoked when the customer embarks in a journey/interaction/engagement (collectively referred to as a “journey”) involving one or more brands. A journey typically involves a series of transactions over a span of time to accomplish a particular goal. For example, booking a vacation may be deemed to be a customer journey that involves interactions with an airline, a hotel, and/or a car rental or rideshare company. Another example of a customer journey may be the purchasing of a home, which might involve interactions with real estate brokers, banks, escrow companies, and insurance companies.

A journey recipe may be considered as the highest level of “direction” on how an engagement is to happen. In one embodiment, a particular journey recipe may define events that trigger the recipe, customer data that are associated with the triggered event, and actions to take based on the triggering of a recipe (or next-steps within the recipe). The recipe may thus consist of commands (e.g. engage, notify, read, update, etc.), vertical specific milestones (e.g. delay, schedule, ship, offer, etc.), and vertical ingredients (e.g. flight, order, shipment, claim, trade, etc.). Additional modifiers may also be defined in the recipe such as, for example, interaction channel, time, and the like.

One example recipe may logically be defined as follows:
Flight=Delayed
   Delay<30 minutes
   Command=Notify via SMS
Flight=Delayed 2^{nd} Time
   Delay>2 hours
   Command=Offer “Update Car Rental” option via [Rental Brand] via SMS
   Offer Engagement=Engage [Car Rental] Agent via SMS
Flight=Delayed 3^{rd} Time
   Delay>6 hours
   Command=Engage via Callback
   Command=Update [Car Rental]+[Hotel Res] with updated arrival if delay has caused date change

In one embodiment, the customer has control of the journey recipes that are to be invoked during a customer journey. In this regard, the customer may select or subscribe to predefined journey recipes stored in the data vault, generate new journey recipes, and/or subscribe to journey recipes recommended to the user based on machine learning. In one embodiment, the journey recipe is automatically executed by the data vault in response to detected trigger events. The actions that are invoked may include updating data or initiating services by other brands trusted by the customer that are linked to the journey recipe. For example, if the event trigger for a vacation customer journey is delay of a flight, a command may be transmitted to a car rental company with a new arrival time, and action might be taken by the car rental company to automatically update the requested reservation time based on the new arrival time.

The automatic sharing of customer data to different brands may provide efficiencies to not only the consumer, but also to the brands involved. For example, the journey recipes not only allow customer to choose how to be engaged/alerted across multiple brands in a single journey, but also provide contextual data back to participating business for use in engagement prediction and/or proactivity. For example, a brand that is notified or a particular event affecting the customer may proactively reach out to the customer based on this information, or predict and plan for inbound contact from the customer. Such planning may include, for example, reserving resources of the contact center for the brand in order to avoid having the customer wait in a queue before being routed to the resources.

The use of machine learning to analyze customer behavior and preference amongst a variety of events and recipes allows for brands to properly forecast future engagement demand across a variety of events, failures, emergencies, and/or increased product/service demand. This forecast may be used to ensure proper resources that may include, for example, additional agents, communication channels, or automated systems capability.

Further benefits of journey recipes include the improvement of customer engagement, the provision of better cross-sell/up-sell opportunities, and the improvement of customer experience metrics. With the customer being in charge of the subscribed journey recipes, the customer is further in control of data that is shared with the different brands, as well as visibility on how their data interacts across brands. The customer may opt-in and opt-out to journey related services and notifications at any time via the centralized data vault.

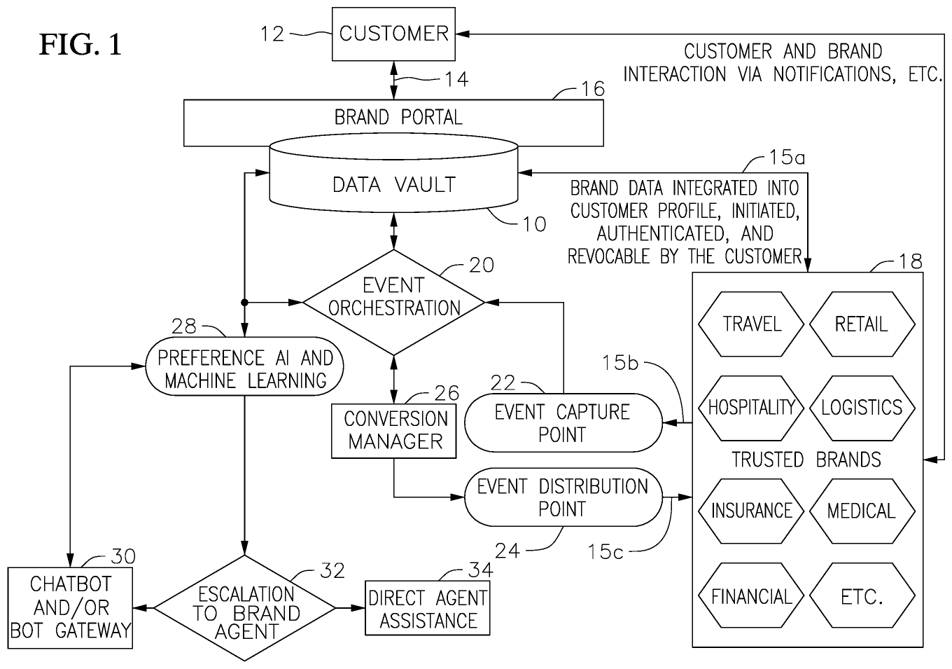

FIG. 1 is block diagram of a system for managing and sharing customer data across computing systems of different brands according to one exemplary embodiment.

The system includes a data vault 10 coupled to end devices of customers 12 over a data communications link 14. The data vault 10 acts as an information broker between various entities 18 that are trusted by the customer 12. Although a single customer 12 is denoted in FIG. 1 for illustration purposes, a person of skill in the art should recognize that that the data vault 10 may provide servers to multiple users at the same time.

The data vault 10 may be hosted, for example, by one or more servers that may also host infrastructure for providing contact center services. The data communications link 14 to the data vault 10 may include a connection to a local area network (LAN), private wide area network (WAN), and/or public wide area network such as, for example, the Internet. A similar data communication link 15a-15c may allow the exchange of data between the data vault and the trusted brands.

According to one embodiment the data vault 10 exposes its capabilities to the customers via a brand portal 16. The brand portal 16 may take the form of, for example, a website, mobile application, or the like, that acts as a gateway to the data vault 10, to allow the customers to enter their profile/preference data, identify trusted brands 18, and subscribe to journey recipes. The brand portal 16 may further provide the customers the option to opt-in and opt-out to one or more of the trusted brands, to provide or revoke access to the customer data at-will, at any time. In this manner the customer data remains under the control of the customer at all times.

The brands 18 that may be available for being selected by the customers include entities in any industry vertical, either affiliated or not affiliated with one another, that may have agreed to be made available to be selected by the customers. Such entities include, for example, entities in the travel industry, retail industry, hospitality industry, logistics industry, insurance industry, medical industry, financial industry, and more.

The various trusted brands 18, selected by the customer, exchange brand data and customer data with the data vault 10 via an application programming interface (API), such as, for example, the REST API. The APIs are published to the participating brands to standardize the commands, such as POST/GET events, to and from the data vault 10. Any of various well known authentication mechanisms may be used to ensure the security and authenticity of the brand and customer data exchanged between the brands and the data vault 10. Such mechanisms may include, for example, the use of token and/or encryption keys as are known in the art. The type of brand or customer information that may be exchanged include, but are not limited to, customer's channel preference data, journey state information, journey events, customer loyalty/authentication information, defined actions/reactions from recipes, and the like.

The data exchanged between the brands 18 and the data vault 10 may trigger proactive/reactive actions as dictated by a particular journey recipe. According to one embodiment, the data vault 10 engages in event orchestration 20 to capture events 22 posted by the trusted brands 18 as the customers interact with the brands, and to distribute events 24 to the appropriate trusted brands 18 based on the actions dictated by the relevant journey recipes. In one example, when the customer 12 engages in a particular interaction with a trusted brand 18 (e.g., when the user 10 makes a flight reservation at an airline website) during a particular journey, the trusted entity 18 (e.g., an inbound/outbound server of the contact center of the trusted entity 18) sends an event notification to the data vault 10 via the API interface 100. According to one embodiment, the event includes embedded information that identifies the customer 12 (e.g., the user's unique identifier, name, email, loyalty number, etc.), token/key associated with the brand for securing and authenticating the received data, and event data (e.g. flight reservation details).

In one embodiment, a conversation manager 26 is configured to capture context or state of interactions associated with a customer's journey, for determining a next event (if any) to be taken in response to the captured context. In one embodiment, the selection of the next event is determined based on the journey recipe associated with the customer's journey, and the captured context. For example, the selected next event may be the sharing of information provided by one brand, to another brand authorized by the customer 12. In a specific example, a customer's vacation recipe may cause information from a booked flight to be shared, for example, with a booked hotel. Given the vacation recipe, the customer has control on how to automate the adjustment/change of services/notifications to the booked hotel (and other brands selected by the customer), to automatically adjust the rental/stay dates in response to data from the booked flight, that the flight has been canceled or delayed.

Events that are selected by the conversation manager for distribution may also relate to other industry verticals. For example, the customer may be subscribed to a “financial loan” journey recipe that states that if the customer performs a search for a loan, events may be posted to trusted financial institutions identified in the customer's “financial loan” journey recipe to perform, for example, automatic searches of rates by those institutions. The result of the searches may be provided to the customer according to a communication channel that may also be identified in the journey recipe. In another example, the journey recipe may state that results of opening an account with one financial institution may be shared with other trusted financial institutions (e.g. insurance, auto, bank), for automatically receiving quotes from those institutions (e.g. new insurance policy/quote, etc.).

The customer may also be subscribed to a “retail” journey recipe to cause the posting of events with trusted brands in the retail industry. Such events might be the posting of the customer's preference relating to shipping, sizing, and/or styling, with the trusted brands. The “retail” journey recipe may also state that a trigger event notifying a delayed shipment from retailer A, will transmit a command that results in a reorder or automatic application of a discount with the same retailer A, or automatic placement of the order with another retailer B, with the same shipping/payment information, if the new purchase price is within a threshold amount of the original purchase.

Power outage could also be alerted and reported via an IoT device in the customer's home via a “utilities” journey recipe. The “utilities” journey recipe may set forth, for example, the order and the timing of the alerts as follows:
IF: power out via (appliance #1)±5 minutes, alert [customer]; >15 minutes, alert [utility]; >30 minutes (and [season/month]), alert plumber of potential pipe freeze.

In one embodiment, the commands that are selected by the conversation manager 26 to effectuate the next step in the journey recipe, may take into account context and preference data of the customers and brands. For example, if the next step in the journey recipe indicates notification to the customer for a trigger event, the conversation manager 26 may consider the communication preferences of the customer as stored in the customer's profile. If the notification is to be performed by the brand itself, the conversation manager 26 may consider profile information of the brand in generating the command. For example, the profile of the brand may indicate that the brand supports customer callbacks. In response to this information, the conversation manager 26 may post a callback command to the brand, with the customer's contact information, preference information, and any available profile or context data that the brand may find useful in interacting with the customer.

The system in the embodiment of FIG. 1 contemplates that the computing system hosting the data vault 10 further host servers and other resources for providing certain contact center services to the customers 12. Such resources may include, for example, an automated chat bot 30 for engaging in automated conversations with the customers 12. Other resources may include a routing server for routing interactions from the customers 12, to the to the trusted brands, for being handled by agents 34 of the trusted brands.

In one embodiment, the event orchestration 20 invokes artificial intelligence capabilities 28 to determine whether an interaction with a customer, due to an event selected by the conversation manager, should be handled via the automated chat bot 30, or escalated 32 to the human agent 34. The interaction may be a proactive interaction or a predicted interaction. A proactive interaction may involve, for example, transmitting a notification to the customer via SMS, email, callback, automated chat, and the like. A predicted interaction may be, for example, an inbound/reactive interaction from the customer that may be predicted or expected in light of the event generated by the conversation manager.

Although the embodiment of FIG. 1 contemplates that the proactive/reactive interactions between the customers 12 and the brand 18 be orchestrated via the one or more servers hosting the data vault 10. A person of skill in the art should recognize that in other embodiments, the interactions may be processed via the contact center infrastructure provided by the brand themselves.

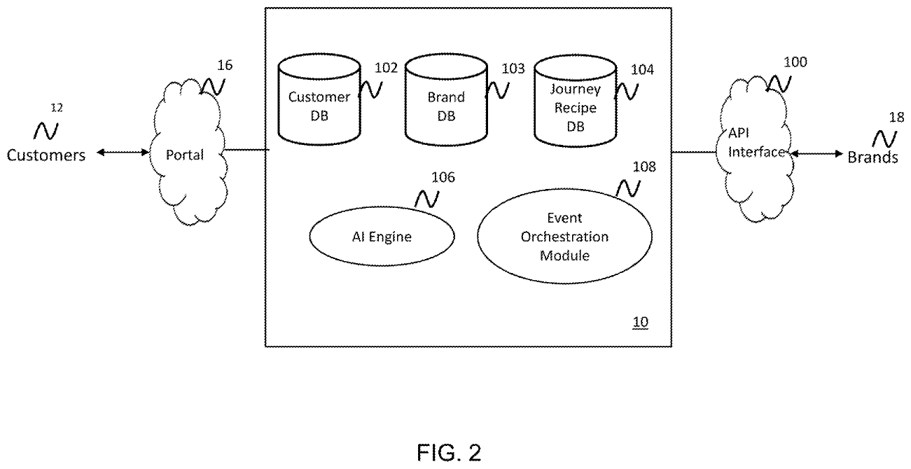

FIG. 2 is a more detailed block diagram of the data vault 10 according to one exemplary embodiment. In the embodiment of FIG. 2, the data vault 10 includes the brand portal 16 that the customers 12 may use to interact with the data vault, and an API interface 100 for engaging in data exchange with the trusted brands 18. In one embodiment, the brand portal 16 is a gateway that includes a graphical user interface that the customer may use to access the different functionalities of the data vault 16. In this regard, the data vault 16 may take the form of a website, mobile application, or the like. The customer may access the brand portal 16 to enter his profile information, select the brands 18 to be linked to his profile, and generate journey recipes to control the sharing of the customer data with the selected brands. The customer's profile may include any customer data including, but not limited to, the customer's contact information, preference data, engagement data, and the like.

In selecting the brands to be linked to the customer's profile, the customer may select the brands from a preset list of participating brands. Once selected, the portal may prompt the customer to provide his authentication information for authenticating the user with each brand. Upon the customer being authenticated with a particular brand, the particular brand may provide a unique token or key for being stored in the user profile. The unique token or key may then be used for securely exchanging customer data with particular brand.

The authenticating of a particular brand with the data vault allows the vault to share customer data with the brand, as specified by the customer. The authenticating also allows the data vault to access the loyalty/profile information maintained by the brand for the customer, and link the loyalty/profile information to the customer's profile in the data vault.

In one embodiment, the graphical user interface provided by the brand portal 16 provides the tools for the customer to manually create journey recipes, subscribe to preexisting recipes (e.g. recommended by the different brands), and/or define recipes as a result of machine learning of prior journey recipes. In one embodiment, the graphical user interface includes visual blocks and wireframe that may be invoked by the customer in generating a journey recipe. The journey recipes may also be created via wizards or templates that guide the customer through each step of the generating, to provide options as to parameters that may be set for a particular recipe. An example wizard for setting up a simple recipe for the user may prompt the user to select the type of information to be shared (e.g. travel booking details), to whom to be shared (all trusted airline brands), and circumstances in which it is to be shared (e.g. when searching for a flights).

The API interface 100 that allows the exchange of data with the brands 18 may be, for example, a REST API interface. The interface may use standard HTTP requests to GET, PUT, POST, and DELETE data/events to and from the data vault 10. In one embodiment, the brands 18 post to the data vault 10, data on interactions with the customers 12. Such interaction data may include, for example, events that can trigger a recipe or next steps within a recipe. The trigger events may vary depending on the industry vertical to which the brands belong. Example trigger events/data include data update/delete/create actions, cancellations, action failures, delay actions, search actions, selection actions, authorization actions, reservation actions, and the like. Other interaction data provided by the brands may depend on the industry vertical. For example, depending on the industry vertical, the interaction data may be reservation/flight information, order information, shipment information, claims submitted, trade information, deposit/withdrawal information, payment information, and the like. For example, an airline may provide, to the data vault 10, reservation information of flights booked by the customer, such as, for example, flight number, seat number, departure time, arrival time, loyalty information, departure location, arrival location, luggage information, and the like. A financial institution may provide, to the data vault 10, information provided by the customer in submitting a car loan application, such as, for example, customer's personal information, financial services/insurance related information, make/model/year of auto applying for, relative cost of vehicle applying for, and the like.

In one embodiment, the API interface 100 is used by the data vault 10 to post commands to the trusted brands 18. Commands may be posted in response to the trigger/milestone events received by the data vault 10, and may identify actions to take based on the triggered events. The commands may be set forth in the particular journey recipe that is invoked, and may contain/interact with data that is unique to the customer profile, data that is offered from another brand that may be uniquely associated to the customer and/or customer journey, and/or data within a brand's existing customer relationship management (CRM)/back-end system. Example commands may include commands to provide notification, initiate an interaction, delete/create/or update requests, trigger services, and the like.

In one embodiment, the data vault 10 includes a customer database 102, brand database 103, journey recipe database 104, artificial intelligence (AI) engine 106, and an event orchestration module 108. The customer, brand, and recipe databases 102-104 may be, for example, Cassandra or NoSQL databases that are stored in a mass storage device conventional in the art. The databases may also be SQL databases, and may be managed by any database management system such as, for example, Oracle, IBM DB2, Microsoft SQL server, Microsoft Access, PostgreSQL, MySQL, FoxPro, and SQLite.

In one embodiment, the customer database 102 stores the profiles of the customers 12, information on the trusted brands 18 linked to the customers, and any other data associated with the customers and their engagements with the trusted brands. In one embodiment, the customer profile/loyalty data that a brand may maintain on its site for a particular customer, is imported to the data vault 10 and stored in association with the profile of the particular customer. In this manner, the customer may control and manage profile/loyalty information for each brand, from a central location.

The brand database 103 may store the profiles of the various trusted brands 18. Such profile information may include, for example, identification of an industry vertical to which the brand belongs, and other general information about the brand including address, telephone number, goods and services provided by the brand, and the like. In one embodiment, the brand database 103 also stores communication capabilities of the brand's contact center. For example, the profile for the brand may indicate that the brand's contact center may engage in SMS, chat, email, and voice communications. The profile may further indicate different services provided by the brand's contact center, such as, for example, customer callback services.

The journey recipe database 104 may store one or more journey recipes created or identified for the customer manually, or based on recommendation from the AI engine 106. In one embodiment, the trusted brands provide suggested recipes to which the customers may subscribe. The journey recipes may be classified based on, for example, the type of industry vertical to which the recipe relates, or not be classified at all. Having a central repository of all journey recipes provides a wealth of knowledge from which new journey recipes may be created and recommended.

In one embodiment, the AI engine 106 includes logic for automatically recommending journey recipes to customers based on analysis of journey recipes subscribed to by other customers 12. The recommendation may be based on one or more models (e.g., one or more statistical models) that correlate, for example, one or more inputs to the model, to one or more journey recipes. In this regard, the AI engine makes use of a machine learning algorithm, such as a one of various known regression or back propagation algorithms, to generate and update the model based on input data. For example, the AI engine 106 may learn that customers that book flights, hotels, and rideshares, subscribe to a “travel” journey recipe that may be preset in the journey recipe database 104. The AI engine 106 may recommend the “travel” journey recipe to the customer 12 in response to detecting the booking of a flight, hotel, and rideshare, by a particular customer who has not already subscribed to the recommended recipe. For example, the brand portal may send a notification to the customer stating: “It seems that you are planning a vacation. Please subscribe to our travel journey recipe to make sure that updates to your plans are automatically notified to the brands involved.”

In one embodiment, the prediction made by the AI engine 106 may go beyond recommending a preset journey recipe. The AI engine 106 may recommend specific steps of a journey recipe in response to input data. In one example, the model receives input data which may include, but is not limited to, engagements of the customer with one or more brands. In response to the input, the model may output a step that is predicted within a set threshold/confidence. The step might be, for example, a particular trigger and command combination. For example, the AI engine 106 may learn that customers who book flights, hotels, and rideshares include into their recipes, a trigger for a flight delay, and an associated command to send a text notification to the user when the flight delay is triggered, and further send a command to update a reservation request to a rideshare company. In another example, the AI engine 106 may learn that customers who apply for car loans also request quotes from insurance companies for car insurance. Based on such learning, the AI engine may recommend to a customer that has engaged in a loan application process, a journey recipe that automatically initiates a request to the trusted brands 18 of the customer that are identified as being insurance companies, and obtains the quotes from the insurance companies. In recommending the journey recipe, the AI engine 106 may further predict the data that needs to be shared to the insurance company, along with the command to provide a quote. Some of the data to be shared may be data that was already provided by the customer in applying for the car loan.

In one embodiment, the event orchestration module 108 monitors customer journeys, and events posted by the brands 18 as the customer engages in the journeys. For example, the event orchestration module 108 monitors events posted by the various brands, including events indicating the creating, updating, or closing of a particular journey. According to one embodiment, a create event triggers the opening of a new service record associated with a journey. Examples of events that open a service record for the airline industry may include “New Ticket Issued”, “New Reservation Issued”, and/or the like. In this example, the new service record or journey may be identified as an “airline reservation” service or journey that may be identified via a unique service record or journey ID. Examples of create events for the finance industry may include “New Credit Card Requested” (for a “credit card application” journey), “New Home Loan Requested” (for a “mortgage” journey), “New Personal Loan Requested” (for a “personal loan” journey), “New Auto Loan Requested” (for a “car loan” journey), and/or the like. A user may have one or more open journeys at a time.

Update events trigger an update of an existing open service record for the particular customer. Examples of events that update a service record for the airline industry may include “Existing Reservation Changed”, “Existing Reservation Upgraded”, “Flight delayed”, and/or the like. Examples of events that update a service record for the finance industry may include “Credit Card—More Info Requested”, “Home Loan—More Info Requested”, “Auto Loan—More Info Requested”, “Documents For A Loan Received”, and/or the like.

Close events trigger the closing of an existing open service record for the particular customer. Examples of events that close a service record for the airline industry may include “Flight Landed”, “Reservation Cancelled”, “Account Cancelled”, and/or the like. Examples of events that close a service record for the finance industry may include “Credit Card Request Denied/Approved”, “Home Loan Request Denied/Approved”, “Auto Loan Request Denied/Approved”, and/or the like.

In one embodiment, the event orchestration module 108 works with the conversation manager 26 to select a recipe, or next steps within the selected recipe, to be invoked for a particular customer. In some embodiments, the event orchestration module initiates outbound interactions with the customers to transmit to the customers, notifications or messages provided by the particular brands during the customer journey. The event orchestration module may further process inbound interactions from the customers, and route the interaction, as needed, to the brand's contact center system. In this regard, the event orchestration module may have access to typical contact center infrastructure (e.g. routing servers, statistics servers, etc.) conventional in the art.

In one embodiment, a journey recipe includes recipe milestones, recipe ingredients, and recipe commands. The journey recipe may take the form of any computerized set of rules and associated commands (e.g. IF/THEN statements) that may be generated, for example, via any computer scripting language conventional in the art.

Recipe milestones may include events that can trigger a recipe or next-steps within a recipe. Such milestones may vary by brand/vertical, and may be discovered/offered via machine learning based on other customer journeys, requests, and/or brand offers. Exemplary milestones include, without limitation, cancellation events, failure events, delay events, search events, selection events, authorization events, reservation events, data update/delete/create events, and/or the like.

Recipe ingredients may be specific data blocks that milestones involve/interact with, and that commands can be packaged with. Data within an ingredient may be populated by the customer's profile in the data vault, data that is offered from another brand and tokenized to be unique to the customer's recipe or profile, and/or data within a brand's existing CRM/back-end system. Recipe ingredients may vary by brand/vertical, or may be discovered/offered via machine learning based on other created recipes, requests, brand offers, or the like. Exemplary recipe ingredients include, without limitation, flight information, order information, shipment information, claim information, trade information, deposit information, withdrawal information, payment information, search information, customer profile information (contact, preference, etc.), and/or the like.

Recipe commands may be actions to take based on the triggering of a recipe or next-steps within a recipe. Commands directed to the brands are posted via the API interface 100. In one embodiment, commands contain/interact with the recipe ingredients, data that is offered from another brand and tokenized to be unique to the customer's recipe or profile, and/or data within a brand's existing CRM/back-end system. Exemplary commands include, without limitation, commands to create, modify, update, read, delete, search, engage in proactive interaction, and/or the like.

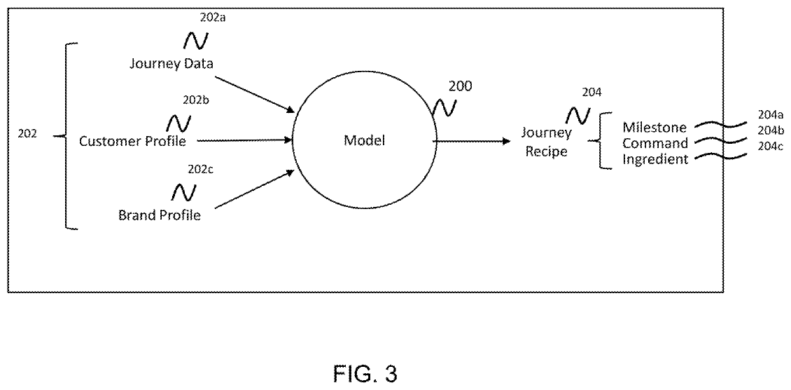

FIG. 3 is a conceptual diagram of the AI engine 106 for recommending journey recipes according to one exemplary embodiment. According to the embodiment of FIG. 3, the AI engine 106 includes a model (e.g., statistical model) 200 that correlates a plurality of input data 202, to journey recipes 204 stored in the journey recipe database 104. The input data 202 may include, for example, the customer's journey data 202a, customer's profile data 202b, and/or brand profile data 202c for the brands invoked during the customer's journey. Based on the given input data 202, the model 200 outputs an identifier to the recommended journey recipe, and/or specific details of the journey recipe such as, for example, the recipe milestones/triggers 204, commands 204b, and ingredients 204c. In one embodiment, the journey recipe and/or details of the journey recipe are selected for recommendation if the selected recipe and/or details of the recipe, are predicted to be correlated to the input provided to the model, within a threshold level of confidence. The AI engine 106 may be configured to recommend all recipes and/or details of the recipe that satisfy the threshold, or simply recommend the recipe and/or details of the recipe that have the highest confidence level above the preset threshold.

In one embodiment, the model 200 may be implemented as a neural network and/or deep neural network (a deep neural network being a neural network that has more than one hidden layer, for use with deep learning techniques), and the process of generating the model 200 may involve training the deep neural networks using training data and an algorithm, such as a back propagation algorithm.

In one embodiment, the model 200 may include a set of weights for each of the parameters of linear regression model, or the model may include a set of weights for connections between the neurons of a trained neural network. In one embodiment, the input data 202 is supplied to the model as values to the input layer of the neural network, and the values (or a set of intermediate values) are forward propagated through the neural network to generate an output, where the output corresponds to a prediction of the journey recipe correlated to the particular input values.

In one embodiment, training of the model is based on journey recipes to which actual customers have subscribed. The model may be trained with examples of correlations between different types of engagements in a customer's journey, different customer profile data, and different brand types, to journey recipes that were invoked by the customers during specific journeys.

In one embodiment, the AI engine 106 continuously refines the model 200 based on, for example, whether the customer accepted a recommended journey recipe, new journey recipes created by customers or recommended by the brands, new customers or brands using the system, and/or the different engagements and journeys embarked by the customers of the system.

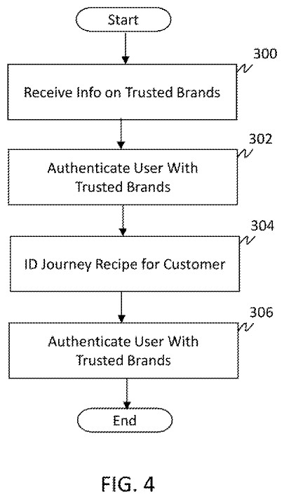

FIG. 4 is a flow diagram of a process for managing and sharing customer data across multiple brands according to one exemplary embodiment. The process starts, and in act 300, the data vault 10 receives information on trusted brands 18 selected by the customer 12. The brands may be selected by the customer from, for example, a drop-down list of brands displayed on the brand portal 16. Once selected, the brands, and any customer profile/loyalty data separately maintained by the brands for the customer, are linked to the customer profile in the data vault 10.

In act 302, the data vault transmits one or more messages to the identified brands for authenticating the customer with the brands. The authentication may be based, for example, on express authentication information provided by the customer for each brand. The authenticating of the user with each brand via the data vault 10 allows the bi-directional transfer of data between the data vault and the authenticated brands. A token or secret key may be exchanged between the data vault 10 and the authenticated brands for ensuring security and authenticity of the data exchanged with the data vault. In addition, the authenticating of the user with the brands via the data vault 10 may cause the setting of a flag in the customer profile maintained by the brand, to indicate that events relating to engagements/interactions associated with the customer are to be posted to the data vault 10 via the API interface 100.

In act 304, the data vault 10 identifies one or more journey recipes for the customer. For example, the brand portal 16 may provide a list of preset journey recipes from the recipe database 104 that relates to the trusted brands, and the customer may select/subscribe to the one or more of the preset journey recipes. The customer may at any time unsubscribe to the selected recipes to prevent cross-entity sharing of the customer data.

The customer may also manually generate a journey recipe based on guidance from a journey wizard application or template. In addition, the AI engine 106 may recommend journey recipes (or specific steps within the journey recipes) based on the brands identified by the customer, the customer profile data, customer engagement with the brands, and/or the like.

Once identified, the journey recipe for the customer may be linked to the specific customer and to the specific brands that are involved, in the customer database 102.

In act 306, the data vault 10 invokes the journey recipe to control the sharing of the customer data with particular trusted brands as set forth in the journey recipe.

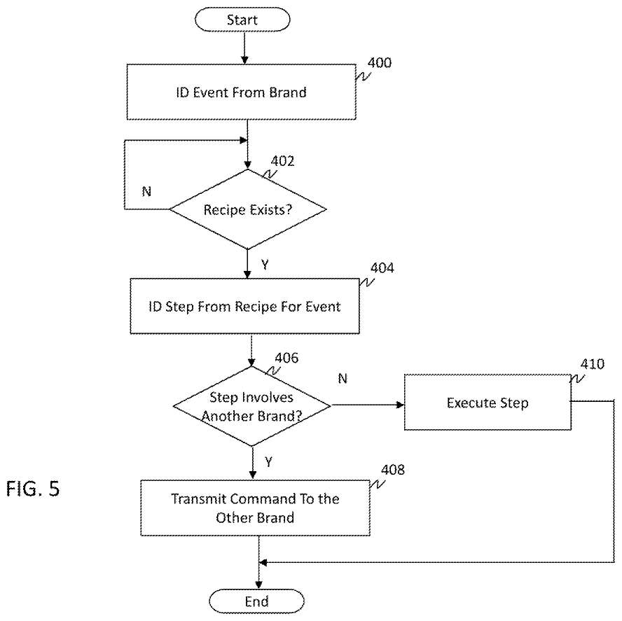

FIG. 5 is a more detailed flow diagram of the process in act 306 for controlling cross-entity sharing of the customer data with the trusted brands according to one exemplary embodiment. In act 400, the event orchestration module 108 monitors for events from the various brands linked to the customer's profile. When an event from a particular brand (Brand A) is posted to the data vault via the API interface 100, the orchestration module 108 determines, in act 402, whether there is a journey recipe for the customer that is linked to Brand A. The orchestration module 108 may also determine whether the customer has an open service record for a customer journey involving Brand A. If not, and this the start of a new journey, the orchestration module 108 may open a new service record.

If response to the inquiry in act 402 is YES, the orchestration module 108 retrieves a file containing the customer's journey recipe from the journey recipe database 104, and in step 404, identifies a step in the recipe that is associated with the detected event. If the answer is NO, and Brand A, although selected by the customer, is not linked to any journey recipe of the customer, the event from Brand A is, in one embodiment, just ignored.

In act 406, the orchestration module 108 determines whether the identified step involves another trusted brand (Brand B) also linked to the recipe. If the answer is YES, the orchestration module transmits, in act 408, a command to Brand B. In doing so, the orchestration module may determine whether the customer has an open service record for the customer journey involving Brand B. In one embodiment, the command to Brand B may include all or a portion of the event data that is posted by Brand A along with the event. Upon receipt of the command by Brand B, Brand B may engage in transactions or further engagements with the customer. Such transactions or engagements may be effectuated via the computing systems associated with Brand B, or via the computing systems associated with the data vault.

If the identified step does not involve another trusted brand, the step is assumed to be for executing by the data vault, and the data vault proceeds to execute the step in act 410.

Described below are use cases exemplifying the use of recipes to control the cross-entity sharing of customer data with different trusted brands linked to a particular customer.
Travel Recipe:
   Ingredients:
      Flight Reservation (Can include Loyalty Info, Seat/Ticket, Luggage, Departure Time, Arrival Time, Departure Location, Arrival Location, etc.)
      Car or Rideshare Reservation (Can include Loyalty Info, Type/Class, Rent Start Time, Rent End Time, Rental Location, Rate, pickup, drop-off, etc.)
      Hotel Reservation (Can include Loyalty Info, Room Type, Check In Time, Check Out Time, Location, Rate, etc.)
      Data Vault Profile Information (Can include contact info, contact preference, customer contextual data, etc.)
   1. [Trigger]—Flight Info Change [Delay]
   2. [Command]—Proactive Interaction
      Uses Data Vault Profile info to trigger an alert to customer based on defined time threshold, event threshold, with additional data/action as defined by machine learning or by customer preference
      Example Alert: “Your Flight has been delayed by more than 30 minutes. Your Rideshare request at [destination] may be at risk, should we update your rideshare request information based on your new arrival time?”
         A customer response would dictate action/trigger in this example
      Example Alert: “Your Flight has been delayed by more than 30 minutes. We've adjusted your rideshare request to account for your new arrival time.”
         Machine learning has determined that this is the right option for the customer, based on past experience or volunteered preference in similar scenarios
   3. [Command]—Update Rideshare Request
      Based on the Machine Learning example in step 2, data vault will consume the data offered in the [airline] trigger, and initiate an update request to the rideshare entity's back-end system, updating the end-user's request based on new arrival time from [airline]'s data in the trigger, authenticated with the end-user's information in data vault.
         Failure/Success notifications could be sent to the customer at this stage depending on machine learning of best outcome, or defined customer preference
   4. [Command]—Proactive Interaction
      Updates customer to the status of their rideshare information

Assuming the above travel recipe ingredients, the following triggers and commands may be identified in another exemplary travel recipe.
1. [Trigger]—Flight Info Change [Cancellation] [Rebooking]
2. [Command]—Proactive Interaction
   “We see that your flight to [destination] has been cancelled. We're able to update your hotel reservation and rideshare request to account for your rebooked flight. Would you like to automatically update your trip reservations based on this flight rebooking?”
      Customer can take action as a result of this—respond in the affirmative, negative, or request additional help. Intent ID/Machine Learning determines this response accordingly.
      If the customer requests additional help, data vault recipe can identify what stage of the journey/recipe requires assistance via Intent ID/Machine Learning and initiate a command to that brand to establish communication/interaction with the customer
   Customer responds with a request for help—the part of the journey that was identified as requiring help is the hotel reservation. Data vault responds appropriately based on customer context, preference, or intent ID/machine learning.
3. [Command]—Update [Hotel Reservation]
   Data vault sends new notes/requests to [hotel brand]'s back end systems to account for the flight cancellation/rebooking and request for a reservation update.
4. [Command]—Proactive Interaction [with Hotel Brand]
   The hotel brand has specified how proactive communication can be established via data vault based on what channels/capabilities [hotel brand] has available. Data vault knows that [hotel brand] supports Callback, and has submitted a [callback] command with the hotel brand with the customer's contact information based on customer preference for voice interactions (either by manual definition or by machine learning). Any additional data vault info that is available (profile, other brand's flight info, etc.) can be passed to [hotel brand] via the data vault API for their use in serving the customer and the right context.
Financial Services Recipe:
   Ingredients:
      Car Loan Application (Can include personal info, financial services/insurance related info, make/model/year of auto applying for, relative cost of vehicle applying for, etc.)
      Bank Account (Can include personal info, financial services related info, accounts held, age of accounts, other credit information, etc.)
      Insurance Account (Can include personal info, insurance related info, age of account, coverage held on other vehicles, qualification for offers, etc.)
      Data vault Profile Information (Can include contact info, contact preference, customer contextual data, etc.)
   1. [Trigger]—Car Loan Application Filed [Selection/Creation Milestone]
   2. [Command]—[Read] allowed/available car loan application variables and use as necessary/permissioned in the rest of the recipe
   3. [Command]—Initiate Request for Insurance Quote with info from [Car Loan App] and [DataVault]; [Create] Quote Request with [Insurance Account], [Search] Competitive Offers & [Create] Quote Request with Market Competitors (either offered to or manually selected by the data vault user)
      Data vault receives a trigger from the customer's Bank of choice that a new car loan application is being filed. This triggers a series of requests to search for new auto insurance policy quotes based on the customer's established relationships and based on preference for searching the market at-large for a quote on their new vehicle. New quotes from other insurance providers can be sent to the customer via SMS initiated by data vault; or, other insurance companies can reach out to the customer directly depending on data vault stored preference/contact methods. The method/timing of contact and interaction with the customer can be determined via machine learning to discern when, in what channel, and with what information the customer may be looking for.
   4. [Trigger]—Quote Received from the customer's current Insurance Company
      Data vault receives a trigger from the customer's existing insurance relationship that a new quote is available for them and sends a command for interaction to data vault
   5. [Command] Proactive Interaction with [Read] from insurance provider's quote system
      Data vault reaches out to the customer with a response to their automated insurance quote search and notifies them that a new quote is available from their existing Insurance Provider. Data vault contextually adds pieces of the provider's quote into the communication form, having used the [Read] command to access the insurance provider's quote tool. The customer can choose to acknowledge and return to the quote at a later time; or, data vault can initiate an interaction request to bridge the customer with an insurance agent to finalize the transaction. The customer can also respond in the affirmative to have data vault send the command to the insurance company to confirm and book the quote, initiating additional steps in the required process to finalize the insurance purchase.

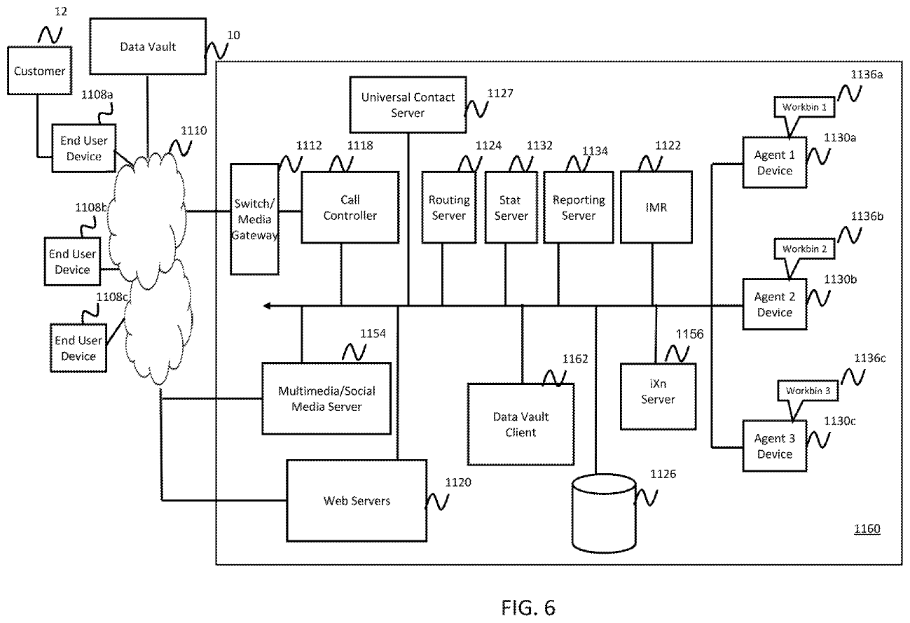

FIG. 6 is a schematic block diagram of a computing system 1160 of a contact center that supports a particular trusted brand 18 according one exemplary embodiment. A person of skill in the art should understand that the data vault 10 may also be hosted in a similar computing system to engage in interactions with the customers 12, and to route interactions to the trusted brands 18 for handling via resources of the trusted brands.

The contact center may be an in-house facility to the particular trusted brand 18 to perform the functions of sales and service relative to the products and services available through the brand. In another aspect, the contact center may be operated by a third-party service provider. According to some embodiments, the contact center may operate as a hybrid system in which some components of the contact center system are hosted at the contact center premise and other components are hosted remotely (e.g., in a cloud-based environment). The contact center may be deployed in equipment dedicated to the brand or third-party service provider, and/or deployed in a remote computing environment such as, for example, a private or public cloud environment with infrastructure for supporting multiple contact centers for multiple enterprises. The various components of the contact center system may also be distributed across various geographic locations and computing environments and not necessarily contained in a single location, computing environment, or even computing device.

According to one example embodiment, the contact center system 1160 manages resources (e.g. personnel, computers, and telecommunication equipment) to enable delivery of services via telephone or other communication mechanisms. Such services may vary depending on the type of contact center, and may range from customer service to help desk, emergency response, telemarketing, order taking, and the like.

Customers, potential customers, or other end users (collectively referred to as the customers 12) desiring to receive services from the contact center may initiate inbound communications (e.g., telephony calls) to the contact center via their end user devices 1108a-1108c (collectively referenced as 1108). Each of the end user devices 1108 may be a communication device conventional in the art, such as, for example, a telephone, wireless phone, smart phone, personal computer, electronic tablet, and/or the like. Users operating the end user devices 1108 may initiate, manage, and respond to telephone calls, emails, chats, text messaging, web-browsing sessions, and other multi-media transactions.

Inbound and outbound communications from and to the end user devices 1108 may traverse a telephone, cellular, and/or data communication network 1110 depending on the type of device that is being used. For example, the communications network 1110 may include a private or public switched telephone network (PSTN), local area network (LAN), private wide area network (WAN), and/or public wide area network such as, for example, the Internet. The communications network 1110 may also include a wireless carrier network including a code division multiple access (CDMA) network, global system for mobile communications (GSM) network, or any wireless network/technology conventional in the art, including but to limited to 3G, 4G, 5G, LTE, and the like.

According to one example embodiment, the contact center system includes a switch/media gateway 1112 coupled to the communications network 1110 for receiving and transmitting telephony calls between the customers 12 and the contact center. The switch/media gateway 1112 may include a telephony switch or communication switch configured to function as a central switch for agent level routing within the center. The switch may be a hardware switching system or a soft switch implemented via software. For example, the switch 1112 may include an automatic call distributor, a private branch exchange (PBX), an IP-based software switch, and/or any other switch with specialized hardware and software configured to receive Internet-sourced interactions and/or telephone network-sourced interactions from a customer, and route those interactions to, for example, an agent telephony or communication device. In this example, the switch/media gateway establishes a voice path/connection (not shown) between the calling customer and the agent telephony device, by establishing, for example, a connection between the customer's telephony device and the agent telephony device.

According to one exemplary embodiment of the invention, the switch is coupled to a call controller 1118 which may, for example, serve as an adapter or interface between the switch and the remainder of the routing, monitoring, and other communication-handling components of the contact center.

The call controller 1118 may be configured to process PSTN calls, VoIP calls, and the like. For example, the call controller 1118 may be configured with computer-telephony integration (CTI) software for interfacing with the switch/media gateway and contact center equipment. In one embodiment, the call controller 1118 may include a session initiation protocol (SIP) server for processing SIP calls. According to some exemplary embodiments, the call controller 1118 may, for example, extract data about the customer interaction such as the caller's telephone number, often known as the automatic number identification (AN I) number, or the customer's internet protocol (IP) address, or email address, and communicate with other contact center components in processing the interaction.

According to one exemplary embodiment of the invention, the system further includes an interactive media response (IMR) server 1122, which may also be referred to as a self-help system, virtual assistant, or the like. The IMR server 1122 may be similar to an interactive voice response (IVR) server, except that the IMR server 1122 is not restricted to voice, but may cover a variety of media channels including voice. Taking voice as an example, however, the IMR server 1122 may be configured with an IMR script for querying customers on their needs. For example, a contact center for a bank may tell customers, via the IMR script, to “press 1” if they wish to get an account balance. If this is the case, through continued interaction with the IMR server 1122, customers may complete service without needing to speak with an agent. The IMR server 1122 may also ask an open ended question such as, for example, “How can I help you?” and the customer may speak or otherwise enter a reason for contacting the contact center. The customer's response may then be used by a routing server 1124 to route the call or communication to an appropriate contact center resource.

If the communication is to be routed to an agent, the call controller 1118 interacts with the routing server (also referred to as an orchestration server) 1124 to find an appropriate agent for processing the interaction. The selection of an appropriate agent for routing an inbound interaction may be based, for example, on a routing strategy employed by the routing server 1124, and further based on information about agent availability, skills, and other routing parameters provided, for example, by a statistics server 1132.

In some embodiments, the routing server 1124 may query a customer database, which stores information about existing clients, such as contact information, loyalty information, service level agreement (SLA) requirements, nature of previous customer contacts and actions taken by contact center to resolve any customer issues, and the like. The database may be, for example, Cassandra or any NoSQL database, and may be stored in a mass storage device 1126. The database may also be a SQL database and may be managed by any database management system such as, for example, Oracle, IBM DB2, Microsoft SQL server, Microsoft Access, PostgreSQL, MySQL, FoxPro, and SQLite. The routing server 1124 may query the customer information from the customer database via an ANI or any other information collected by the IMR server 1122.

Once an appropriate agent is identified as being available to handle a communication, a connection may be made between the customer 12 and an agent device 1130a-1130c (collectively referenced as 1130) of the identified agent. Collected information about the customer and/or the customer's historical information may also be provided to the agent device for aiding the agent in better servicing the communication. In this regard, each agent device 1130 may include a telephone adapted for regular telephone calls, VoIP calls, and the like. The agent device 1130 may also include a computer for communicating with one or more servers of the contact center and performing data processing associated with contact center operations, and for interfacing with customers via voice and other multimedia communication mechanisms.

The contact center system may also include a multimedia/social media server 1154 for engaging in media interactions other than voice interactions with the end user devices 1108 and/or web servers 1120. The media interactions may be related, for example, to email, vmail (voice mail through email), chat, video, text-messaging, web, social media, co-browsing, and the like. In this regard, the multimedia/social media server 1154 may take the form of any IP router/processor conventional in the art with specialized hardware and/or software for receiving, processing, and forwarding multi-media events. For example, the multimedia/social media server 1154 may include a chat server for processing text-based chat conversations, email server or processing emails, SMS server for processing text-messages, and the like.

The web servers 1120 may include, for example, social interaction site hosts for a variety of known social interaction sites to which an end user may subscribe, such as, for example, Facebook, Twitter, and the like. In this regard, although in the embodiment of FIG. 6 the web servers 1120 are depicted as being part of the contact center system, the web servers may also be provided by third parties and/or maintained outside of the contact center premise. The web servers may also provide web pages for the enterprise that is being supported by the contact center. End users may browse the web pages and get information about the enterprise's products and services, and/or purchase/reserve such products and services. The web pages may also provide a mechanism for contacting the contact center, via, for example, web chat, voice call, email, web real time communication (WebRTC), or the like.

According to one exemplary embodiment, in addition to real-time interactions, deferrable (also referred to as back-office or offline) interactions/activities may also be routed to the contact center agents. Such deferrable activities may include, for example, responding to emails, responding to letters, attending training seminars, or any other activity that does not entail real time communication with a customer. In this regard, an interaction (iXn) server 1156 interacts with the routing server 1124 for selecting an appropriate agent to handle the activity. Once assigned to an agent, an activity may be pushed to the agent, or may appear in the agent's workbin 1136a-1136c (collectively referenced as 1136) as a task to be completed by the agent. The agent's workbin may be implemented via any data structure conventional in the art, such as, for example, a linked list, array, and/or the like. The workbin 1136 may be maintained, for example, in buffer memory of each agent device 1130.

According to one exemplary embodiment, the mass storage device(s) 1126 may store one or more databases relating to agent data (e.g. agent profiles, schedules, etc.), customer data (e.g. customer profiles and loyalty information), interaction data (e.g. details of each interaction with a customer, including reason for the interaction, disposition data, time on hold, handle time, etc.), and the like. According to one embodiment, some of the data (e.g. customer profile data) may be maintained in a customer relations management (CRM) database hosted in the mass storage device 1126 or elsewhere. The mass storage device may take form of a hard disk or disk array as is conventional in the art.

According to some embodiments, the contact center system may include a universal contact server (UCS) 1127, configured to retrieve information stored in the CRM database and direct information to be stored in the CRM database. The UCS 1127 may also be configured to facilitate maintaining a history of customers' preferences and interaction history, and to capture and store data regarding comments from agents, customer communication history, and the like.

The contact center system 1160 may also include a reporting server 1134 configured to generate reports from data aggregated by the statistics server 1132. Such reports may include near real-time reports or historical reports concerning the state of resources, such as, for example, average waiting time, abandonment rate, agent occupancy, and the like. The reports may be generated automatically or in response to specific requests from a requestor (e.g. agent/administrator, contact center application, and/or the like).

In one embodiment, the contact center system 1600 further includes a data vault client 1162 configured to monitor activities within the contact center, and post events to the data vault 10. The client 1162 is also configured to receive events from the data vault 10 and determine if actions should be taken in response to the received events. Of course, instead of an independent unit, the functionality of the client 1162 may be incorporated into one of the existing servers of the contact center system 1160, such as, for example, the routing server 1124, interaction server 1156, and/or the like.

In one embodiment, the client 1162 receives events from one or more servers of the contact center relating to interactions between the customer and the contact center. In this regard, the one or more servers of the contact center may check the customer profile data maintained by the contact center for the customer, to determine whether the customer has linked the entity behind the contact center, to the customer profile in the data vault 10 (hereinafter referred to as “data-vault customers”). In one embodiment, only the events of data-vault customers are forwarded to the client 1162. In another embodiment, all events of all customer interactions are forwarded to the client, and the client determines which ones relate to the data-vault customers.

Once a determination is made that an interaction event belongs to a data-vault customer, an outbound event is generated for posting to the data vault. In one embodiment, the client 1162 generates outbound events for all events relating to data-vault customers. In another embodiment, the client 1162 generates events for only selected milestone/trigger events, similar to the milestone/trigger events that may be identified in a customer journey recipe. The content of a particular outbound event that is posted to the data vault 10 may include, for example, identification information of the customer, description of the event, and any token/key data that may have been exchanged with the data vault 10 to ensure secure transfer of the data.

In one embodiment, the client 1162 receives inbound events posted by the data vault 10 to the contact center, and identifies resources of the contact center that should be invoked to process the inbound events. The handling of an inbound event is based on the command that is included in the event. For example, if the received event indicates a command to update a hotel reservation date/time, the client 1162 may generate the appropriate message to, for example, the hotel's web servers 1120 or reservation processing server (not shown), to effectuate the update. Further messages may also be transmitted to the call controller 1118 or interaction server 1156 for providing notification of the change to the affected customer 12 (assuming that such notification is not already provided via the system hosting the data vault). Details on the manner and channel of the notification may be provided in the command from the data vault, based on for example, the profile of the customer and/or brand as stored in the data vault.

In another example, if the received event is by a financial institution, and the command is for the financial institution to perform a search for loan or insurance rates, the client 1162 may generate the appropriate message to, for example, the financial institution's web servers or loan/insurance processing server (not shown) to generate a quote. The command may include information on the customer necessary for processing loan. Such information may have been provided, for example, by another trusted brand of the customer, and permitted to be used by the financial institution based on the journey recipe enabled by the customer.

As will be appreciated by a person of skill in the art, the data vault system and method of the various embodiments enable intelligent cross-entity communication of information relating to a customer, among a group of unaffiliated entities (e.g., a group of unaffiliated businesses) that is trusted by the customer. The unaffiliated entities do not exchange user interaction information directly, and information that is needed to improve the user's overall experience in interacting with the trusted entities is shared through the data vault as enabled by the customer via the customer journey recipes. For instance, the identity of an entity that is the source of information being shared remains hidden from the other trusted entities. As such, the data vault 10 allows the group of trusted entities to share critical information anonymously, under the control of the customer.

Accordingly, the data vault system and method of the various embodiments system improves user engagement by entities, reduces user involvement in obtaining proper service, and improves customer satisfaction while protecting the user's data privacy and security. In addition, the dissemination of event information is under the complete control of the customer who may opt-in and opt-out of such sharing at any time.

The various servers described herein may each include one or more processors executing computer program instructions and interacting with other system components for performing the various functionalities described herein. The computer program instructions are stored in a memory implemented using a standard memory device, such as, for example, a random access memory (RAM). The computer program instructions may also be stored in other non-transitory computer readable media such as, for example, a CD-ROM, flash drive, or the like. Also, although the functionality of each of the servers is described as being provided by the particular server, a person of skill in the art should recognize that the functionality of various servers may be combined or integrated into a single server, or the functionality of a particular server may be distributed across one or more other servers without departing from the scope of the embodiments of the present invention.

In the various embodiments, the terms “interaction” and “communication” are used interchangeably, and generally refer to any real-time and non-real time interaction that uses any communication channel including, without limitation telephony calls (PSTN or VoIP calls), emails, vmails (voice mail through email), video, chat, screen-sharing, text messages, social media messages, web real-time communication (e.g. WebRTC calls), and the like.

As described herein, various applications and aspects of the present invention may be implemented in software, firmware, hardware, and combinations thereof. When implemented in software, the software may operate on a general purpose computing device such as a server, a desktop computer, a tablet computer, a smartphone, personal digital assistant, or an embedded system such as a computer system embedded in a device to create an Internet-of-things (IoT) device. Such a general purpose computer includes a general purpose processor and memory.

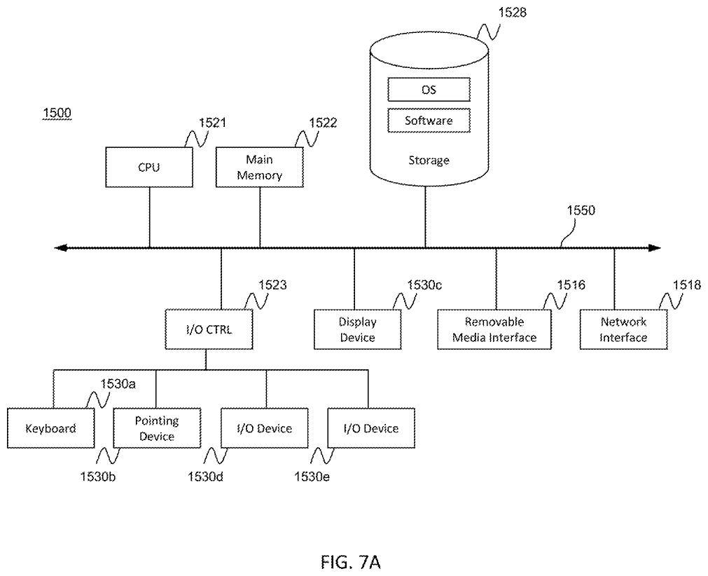

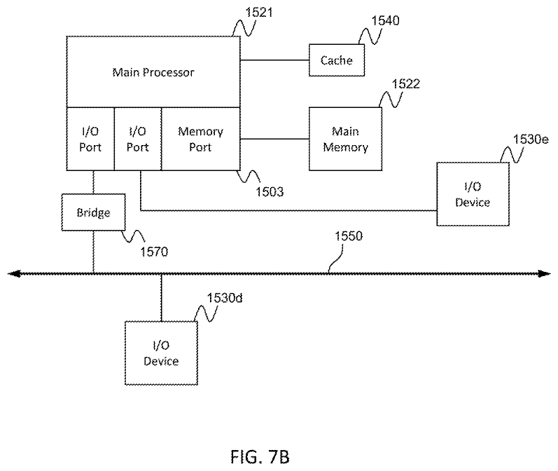

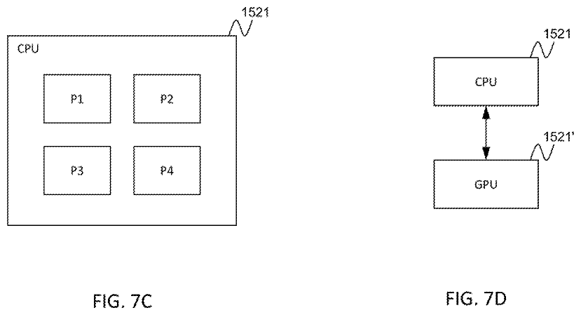

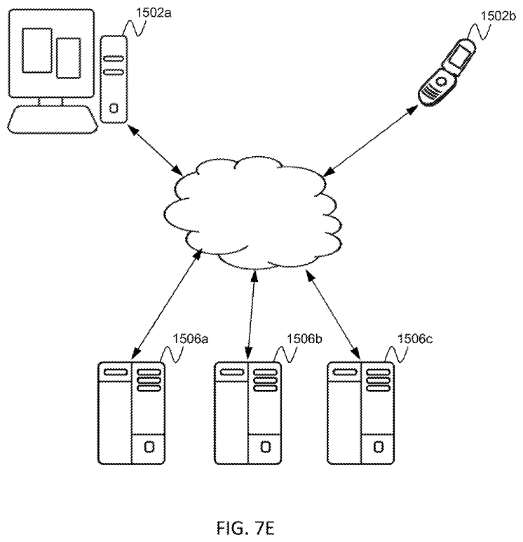

Each of the various servers, controllers, switches, gateways, engines, and/or modules (collectively referred to as servers) in the afore-described figures may be a process or thread, running on one or more processors, in one or more computing devices 1500 (e.g., FIG. 7A, FIG. 7B), executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that a computing device may be implemented via firmware (e.g., an application-specific integrated circuit), hardware, or a combination of software, firmware, and hardware. A person of skill in the art should also recognize that the functionality of various computing devices may be combined or integrated into a single computing device, or the functionality of a particular computing device may be distributed across one or more other computing devices without departing from the scope of the exemplary embodiments of the present invention. A server may be a software module, which may also simply be referred to as a module. The set of modules in the contact center may include servers, and other modules.

The various servers may be located on a computing device on-site at the same physical location as the agents of the contact center or may be located off-site (or in the cloud) in a geographically different location, e.g., in a remote data center, connected to the contact center via a network such as the Internet. In addition, some of the servers may be located in a computing device on-site at the contact center while others may be located in a computing device off-site, or servers providing redundant functionality may be provided both via on-site and off-site computing devices to provide greater fault tolerance. In some embodiments of the present invention, functionality provided by servers located on computing devices off-site may be accessed and provided over a virtual private network (VPN) as if such servers were on-site, or the functionality may be provided using a software as a service (SaaS) to provide functionality over the Internet using various protocols, such as by exchanging data using encoded in extensible markup language (XML) or JavaScript Object Notation (JSON).

FIG. 7A and FIG. 7B depict block diagrams of a computing device 1500 as may be employed in exemplary embodiments of the present invention. Each computing device 1500 includes a central processing unit 1521 and a main memory unit 1522. As shown in FIG. 7A, the computing device 1500 may also include a storage device 1528, a removable media interface 1516, a network interface 1518, an input/output (I/O) controller 1523, one or more display devices 1530c, a keyboard 1530a and a pointing device 1530b, such as a mouse. The storage device 1528 may include, without limitation, storage for an operating system and software. As shown in FIG. 7B, each computing device 1500 may also include additional optional elements, such as a memory port 1503, a bridge 1570, one or more additional input/output devices 1530d, 1530e and a cache memory 1540 in communication with the central processing unit 1521. The input/output devices 1530a, 1530b, 1530d, and 1530e may collectively be referred to herein using reference numeral 1530.

The central processing unit 1521 is any logic circuitry that responds to and processes instructions fetched from the main memory unit 1522. It may be implemented, for example, in an integrated circuit, in the form of a microprocessor, microcontroller, or graphics processing unit (GPU), or in a field-programmable gate array (FPGA) or application-specific integrated circuit (ASIC). The main memory unit 1522 may be one or more memory chips capable of storing data and allowing any storage location to be directly accessed by the central processing unit 1521. As shown in FIG. 7A, the central processing unit 1521 communicates with the main memory 1522 via a system bus 1550.

As shown in FIG. 7B, the central processing unit 1521 may also communicate directly with the main memory 1522 via a memory port 1503.

FIG. 7B depicts an embodiment in which the central processing unit 1521 communicates directly with cache memory 1540 via a secondary bus, sometimes referred to as a backside bus. In other embodiments, the central processing unit 1521 communicates with the cache memory 1540 using the system bus 1550. The cache memory 1540 typically has a faster response time than main memory 1522. As shown in FIG. 7A, the central processing unit 1521 communicates with various I/O devices 1530 via the local system bus 1550. Various buses may be used as the local system bus 1550, including a Video Electronics Standards Association (VESA) Local bus (VLB), an Industry Standard Architecture (ISA) bus, an Extended Industry Standard Architecture (EISA) bus, a MicroChannel Architecture (MCA) bus, a Peripheral Component Interconnect (PCI) bus, a PCI Extended (PCI-X) bus, a PCI-Express bus, or a NuBus. For embodiments in which an I/O device is a display device 1530c, the central processing unit 1521 may communicate with the display device 1530c through an Advanced Graphics Port (AGP). FIG. 7B depicts an embodiment of a computer 1500 in which the central processing unit 1521 communicates directly with I/O device 1530e. FIG. 7B also depicts an embodiment in which local busses and direct communication are mixed: the central processing unit 1521 communicates with I/O device 1530d using a local system bus 1550 while communicating with I/O device 1530e directly.

A wide variety of I/O devices 1530 may be present in the computing device 1500. Input devices include one or more keyboards 1530a, mice, trackpads, trackballs, microphones, and drawing tablets. Output devices include video display devices 1530c, speakers, and printers. An I/O controller 1523, as shown in FIG. 7A, may control the I/O devices. The I/O controller may control one or more I/O devices such as a keyboard 1530a and a pointing device 1530b, e.g., a mouse or optical pen.

Referring again to FIG. 7A, the computing device 1500 may support one or more removable media interfaces 1516, such as a floppy disk drive, a CD-ROM drive, a DVD-ROM drive, tape drives of various formats, a USB port, a Secure Digital or COMPACT FLASH™ memory card port, or any other device suitable for reading data from read-only media, or for reading data from, or writing data to, read-write media. An I/O device 1530 may be a bridge between the system bus 1550 and a removable media interface 1516.

The removable media interface 1516 may for example be used for installing software and programs. The computing device 1500 may further include a storage device 1528, such as one or more hard disk drives or hard disk drive arrays, for storing an operating system and other related software, and for storing application software programs. Optionally, a removable media interface 1516 may also be used as the storage device. For example, the operating system and the software may be run from a bootable medium, for example, a bootable CD.

In some embodiments, the computing device 1500 may include or be connected to multiple display devices 1530c, which each may be of the same or different type and/or form. As such, any of the I/O devices 1530 and/or the I/O controller 1523 may include any type and/or form of suitable hardware, software, or combination of hardware and software to support, enable or provide for the connection to, and use of, multiple display devices 1530c by the computing device 1500. For example, the computing device 1500 may include any type and/or form of video adapter, video card, driver, and/or library to interface, communicate, connect or otherwise use the display devices 1530c. In one embodiment, a video adapter may include multiple connectors to interface to multiple display devices 1530c. In other embodiments, the computing device 1500 may include multiple video adapters, with each video adapter connected to one or more of the display devices 1530c. In some embodiments, any portion of the operating system of the computing device 1500 may be configured for using multiple display devices 1530c. In other embodiments, one or more of the display devices 1530c may be provided by one or more other computing devices, connected, for example, to the computing device 1500 via a network. These embodiments may include any type of software designed and constructed to use the display device of another computing device as a second display device 1530c for the computing device 1500. One of ordinary skill in the art will recognize and appreciate the various ways and embodiments that a computing device 1500 may be configured to have multiple display devices 1530c.

A computing device 1500 of the sort depicted in FIG. 7A and FIG. 7B may operate under the control of an operating system, which controls scheduling of tasks and access to system resources. The computing device 1500 may be running any operating system, any embedded operating system, any real-time operating system, any open source operating system, any proprietary operating system, any operating systems for mobile computing devices, or any other operating system capable of running on the computing device and performing the operations described herein.

The computing device 1500 may be any workstation, desktop computer, laptop or notebook computer, server machine, handheld computer, mobile telephone or other portable telecommunication device, media playing device, gaming system, mobile computing device, or any other type and/or form of computing, telecommunications or media device that is capable of communication and that has sufficient processor power and memory capacity to perform the operations described herein. In some embodiments, the computing device 1500 may have different processors, operating systems, and input devices consistent with the device.

In other embodiments the computing device 1500 is a mobile device, such as a Java-enabled cellular telephone or personal digital assistant (PDA), a smart phone, a digital audio player, or a portable media player. In some embodiments, the computing device 1500 includes a combination of devices, such as a mobile phone combined with a digital audio player or portable media player.

As shown in FIG. 7C, the central processing unit 1521 may include multiple processors P1, P2, P3, P4, and may provide functionality for simultaneous execution of instructions or for simultaneous execution of one instruction on more than one piece of data. In some embodiments, the computing device 1500 may include a parallel processor with one or more cores. In one of these embodiments, the computing device 1500 is a shared memory parallel device, with multiple processors and/or multiple processor cores, accessing all available memory as a single global address space. In another of these embodiments, the computing device 1500 is a distributed memory parallel device with multiple processors each accessing local memory only. In still another of these embodiments, the computing device 1500 has both some memory which is shared and some memory which may only be accessed by particular processors or subsets of processors. In still even another of these embodiments, the central processing unit 1521 includes a multicore microprocessor, which combines two or more independent processors into a single package, e.g., into a single integrated circuit (IC). In one exemplary embodiment, depicted in FIG. 7D, the computing device 1500 includes at least one central processing unit 1521 and at least one graphics processing unit 1521′.

In some embodiments, a central processing unit 1521 provides single instruction, multiple data (SIMD) functionality, e.g., execution of a single instruction simultaneously on multiple pieces of data. In other embodiments, several processors in the central processing unit 1521 may provide functionality for execution of multiple instructions simultaneously on multiple pieces of data (MIMD). In still other embodiments, the central processing unit 1521 may use any combination of SIMD and MIMD cores in a single device.

A computing device may be one of a plurality of machines connected by a network, or it may include a plurality of machines so connected. FIG. 7E shows an exemplary network environment. The network environment includes one or more local machines 1502a, 1502b (also generally referred to as local machine(s) 1502, client(s) 1502, client node(s) 1502, client machine(s) 1502, client computer(s) 1502, client device(s) 1502, endpoint(s) 1502, or endpoint node(s) 1502) in communication with one or more remote machines 1506a, 1506b, 1506c (also generally referred to as server machine(s) 1506 or remote machine(s) 1506) via one or more networks 1504. In some embodiments, a local machine 1502 has the capacity to function as both a client node seeking access to resources provided by a server machine and as a server machine providing access to hosted resources for other clients 1502a, 1502b. Although only two clients 1502 and three server machines 1506 are illustrated in FIG. 7E, there may, in general, be an arbitrary number of each. The network 1504 may be a local-area network (LAN), e.g., a private network such as a company Intranet, a metropolitan area network (MAN), or a wide area network (WAN), such as the Internet, or another public network, or a combination thereof.

The computing device 1500 may include a network interface 1518 to interface to the network 1504 through a variety of connections including, but not limited to, standard telephone lines, local-area network (LAN), or wide area network (WAN) links, broadband connections, wireless connections, or a combination of any or all of the above. Connections may be established using a variety of communication protocols. In one embodiment, the computing device 1500 communicates with other computing devices 1500 via any type and/or form of gateway or tunneling protocol such as Secure Socket Layer (SSL) or Transport Layer Security (TLS). The network interface 1518 may include a built-in network adapter, such as a network interface card, suitable for interfacing the computing device 1500 to any type of network capable of communication and performing the operations described herein. An I/O device 1530 may be a bridge between the system bus 1550 and an external communication bus.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

The terminology used herein is for the purpose of describing particular embodiments and is not intended to be limiting of the inventive concept. As used herein, the singular forms “a” and “an” are intended to include the plural forms as well, unless the context clearly indicates otherwise. It will be further understood that the terms “include”, “including”, “comprises”, and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of”, when preceding a list of elements, modify the entire list of elements and do not modify the individual elements of the list. Further, the use of “may” when describing embodiments of the inventive concept refers to “one or more embodiments of the inventive concept”. Also, the term “exemplary” is intended to refer to an example or illustration.

As used herein, the terms “use”, “using”, and “used” may be considered synonymous with the terms “utilize”, “utilizing”, and “utilized”, respectively.

While this invention has been described in detail with particular references to illustrative embodiments thereof, the embodiments described herein are not intended to be exhaustive or to limit the scope of the invention to the exact forms disclosed. Persons skilled in the art and technology to which this invention pertains will appreciate that alterations and changes in the described structures and methods of assembly and operation can be practiced without meaningfully departing from the principles, spirit, and scope of this invention, as set forth in the following claims and equivalents thereof.

1. A method for managing and sharing data across a plurality of computing systems, the method comprising:
identifying, by a processor, a computerized set of rules and actions;
storing, by the processor, the identified set of rules and actions in association with a specific user of a plurality of users;
monitoring, by the processor, for a trigger event from a first computing system of the plurality of computing systems, the trigger event including first event data;
determining, by the processor, whether the trigger event is identified in the set of rules and actions stored in association with the specific user;
in response to determining that the trigger event is identified in the set of rules and actions, identifying, by the processor, a command from the set of rules and actions corresponding to the trigger event; and
transmitting, by the processor, the command to a second computing system of the plurality of computing systems, wherein the command includes at least a portion of the first event data, wherein the command is for triggering action by the second computing system.

2. The method of claim 1 claim 1 wherein the identifying, by the processor, the computerized set of rules and actions includes:
receiving, by the processor, information on engagements by the specific user with a first entity associated with the first computing system, and a second entity associated with the second computing system;
predicting, by the processor, the set of rules and actions correlated to the received information; and
recommending, by the processor, the predicted set of rules and actions.

3. The method of claim 2, wherein the predicting, by the processor, of the set of rules and actions includes:
maintaining, by the processor, a statistical model modeling a correlation between a plurality of inputs and a plurality of sets of rules and actions;
providing, by the processor, the information on engagements by the specific user, as input to the statistical model; and
selecting, by the processor, the predicted set of rules and actions, wherein the predicted set of rules of actions are predicted to be correlated to the information on engagements by the specific user, within a threshold level of confidence.

4. The method of claim 1, wherein the trigger event is generated in response to a first engagement between the specific user and the first computing system, and the first event data includes data associated with the first engagement.

5. The method of claim 1, further comprising:
receiving, by the processor, user selection of a first entity associated with the first computing system, and a second entity associated with the second computing system;
authenticating, by the processor, the specific user with each of the first and second entities; and
linking the first and second entities to a user profile of the specific user.

6. The method of claim 5, wherein the monitoring of the trigger event from the first computing system is in response to the linking of the first entity to the user profile of the specific user.

7. The method of claim 5, wherein the set of rules and actions is further linked to the first and second entities without linking to a third entity, the method further comprising;
receiving, by the processor, the trigger event from a third computing system of the plurality of computing systems associated with the third entity; and
ignoring, by the processor, the received trigger event from the third computing system.

8. The method of claim 5, wherein the action triggered via the command is an interaction between the specific user and the second computing system.

9. The method of claim 5, wherein the first computing system includes a server for providing contact center services to customers of the first entity, and the second computing system includes a server for providing contact center services to customers of the second entity.

10. A system for managing and sharing data across a plurality of computing systems, the system comprising:
a mass data storage device;
a processor coupled to the mass data storage device; and
a memory coupled to the processor, the memory providing instructions that, when executed by the processor, cause the processor to:
provide a portal accessible to a user, the portal for prompting the user to identify a plurality of entities, each of the plurality of entities being associated with a different computing system of the plurality of computing systems;
receive user authentication information for each of the plurality of entities;
exchange messages with each of the plurality of entities based on the corresponding user authentication information for authenticating the user to each of the plurality of entities;
identify a set of computerized rules and actions involving first and second entities of the plurality of entities;
store the identified set of rules and actions in the mass data storage device in association with the user;
receive an event from the computing system associated with the first entity, the event being generated in response to a first engagement between the user and the first entity, the event including event data associated with the first engagement;
determine whether the event is identified in the set of rules and actions stored in association with the user;
in response to determining that the event is identified in the set of rules and actions, identify a command from the set of rules and actions corresponding to the event; and
transmit the command to the computing system associated with the second entity, the command including at least a portion of the event data, wherein the command is for triggering action for a second engagement between the user and the second entity.

11. The system of claim 10, wherein the instructions that cause the processor to identify the computerized set of rules and actions further include instructions that cause the processor to:
receive information on engagements by the specific user with the first and second entities;
predict the set of rules and actions correlated to the received information; and
recommend the predicted set of rules and actions.

12. The system of claim 11, wherein the instructions that cause the processor to predict include instructions that cause the processor to:
maintain a statistical model modeling a correlation between a plurality of inputs and a plurality of sets of rules and actions;
provide the information on engagements by the specific user, as input to the statistical model; and
select the predicted set of rules and actions, wherein the predicted set of rules of actions are predicted to be correlated to the information on engagements by the specific user, within a threshold level of confidence.

13. The system of claim 10, wherein the instructions further cause the processor to:
in response to authenticating the user to each of the plurality of entities, link the plurality of entities to a user profile of the user.

14. The system of claim 13, wherein the instructions that cause the processor to receive the event from the computing system associated with the first entity is in response to instructions that cause the processor to link the first entity to the user profile of the specific user.

15. The system of claim 13, wherein the set of rules and actions is further linked to the first and second entities without linking to a third entity, and the instructions further cause the processor to:
receive the trigger event from a third computing system of the plurality of computing systems associated with the third entity; and
ignore the received trigger event from the third computing system.

16. The system of claim 13, wherein the first computing system includes a server for providing contact center services to customers of the first entity, and the second computing system includes a server for providing contact center services to customers of the second entity.

17. The system of claim 10, wherein the instructions that cause the processor to receive the first event from the first computing system, and the instructions that cause the processor to transmit the command to the second computing system, further include instructions that cause the processor to receive and transmit over an application programming interface.

18. The system of claim 10, wherein the second engagement is for modifying a result of a prior interaction between the user and the second entity.
